(19) United States
(12) Patent Application Publication
(10) Pub. No.: US 2025/0363309 A1
(43) Pub. Date: Nov. 27, 2025

(54) DIALOGUE SUPPORT SYSTEM, DIALOGUE SUPPORT METHOD, AND STORAGE MEDIUM

(71) Applicant: TOPPAN Holdings Inc., Tokyo (JP)

(72) Inventors: Tomoaki NAKAYAMA, Tokyo (JP); Ping ZHANG, Tokyo (JP); Nanami SHIMIZUGAWA, Tokyo (JP)

(73) Assignee: TOPPAN Holdings Inc., Tokyo (JP)

(21) Appl. No.: 19/212,731

(22) Filed: May 20, 2025

(30) Foreign Application Priority Data
May 21, 2024 (JP) 2024-082565
Mar. 11, 2025 (JP) 2025-037941

(51) Int. Cl. G06F 40/35; A63F 13/822; G10L 13/027

(52) U.S. Cl. CPC G06F 40/35; G10L 13/027; A63F 13/822

(57) ABSTRACT

A dialogue support system according to one aspect of the present disclosure includes: a receiver configured to receive persona information indicating a persona that characterizes a dialogue partner of a user, a persona generator configured to generate a persona generation prompt indicating characteristics of the persona based on the persona information received by the receiver using a large language model, and a dialogue controller configured to control an avatar corresponding to the persona based on the persona generation prompt generated by the persona generator, and to control a dialogue between the avatar and the user.

### CROSS-REFERENCE TO RELATED APPLICATIONS

The present application claims priority based on Japanese Patent Application No. 2024-082565, filed May 21, 2024, and Japanese Patent Application No. 2025-037941, filed Mar. 11, 2025, the contents of each are incorporated herein by reference.

### BACKGROUND OF THE INVENTION

### Field of the Invention

The present invention relates to a dialogue support system, a dialogue support method, and a storage medium.

### Description of Related Art

In the related art, as a technology for supporting dialogue with a user, for example, the technology described in Japanese Unexamined Patent Application, First Publication No. 2022-014188 (hereinafter referred to as “Patent Document 1”) is known. Patent Document 1 describes a training system that implements communication AI and is intended to support the education of professionals who require conversation skills. The training system includes a processor configured to execute acquiring an utterance from a student, analyzing the content of the acquired utterance from the student, creating a next utterance content for the student based on the analyzed content of the utterance, and synthesizing a voice representing the utterance content.

### SUMMARY OF THE INVENTION

The dialogue partners, scenes, and situations desired by users are assumed to be various depending on the user's purpose, but the training system described in Patent Document 1 has the problem that it is difficult to change the content of the dialogue according to the attributes of the dialogue partner, scene, and situation. In particular, it is difficult to increase the variation for existing role-playing or to generate realistic role-playing.

The present disclosure has been made in consideration of the above circumstances, and an object of the present disclosure is to provide a dialogue support system, a dialogue support method, and a storage medium that can easily increase the variation of attributes of a dialogue partner and support a dialogue according to the attributes of the dialogue partner.

The present disclosure has been made to solve the above-described problems, and one aspect of the present disclosure is a dialogue support system including: a receiver configured to receive persona information indicating a persona that characterizes a dialogue partner of a user; a persona generator configured to generate a persona generation prompt indicating characteristics of the persona based on the persona information received by the receiver using a large language model; and a dialogue controller configured to control an avatar corresponding to the persona based on the persona generation prompt generated by the persona generator, and to control a dialogue between the avatar and the user.

Another aspect of the present disclosure is a dialogue support method including: a step in which a server device receives persona information indicating a persona that characterizes a dialogue partner of a user; a step in which the server device generates a persona generation prompt indicating characteristics of the persona based on the persona information using a large language model; and a step in which the server device controls an avatar corresponding to the persona based on the persona generation prompt, and controls a dialogue between the avatar and the user.

Another aspect of the present disclosure is a non-transitory computer-readable storage medium storing a program that causes a computer of a server device to execute: a step of receiving persona information indicating a persona that characterizes a dialogue partner of a user; a step of generating a persona generation prompt indicating characteristics of the persona based on the persona information using a large language model; and a step of controlling an avatar corresponding to the persona based on the persona generation prompt, and controlling a dialogue between the avatar and the user.

According to one aspect of the present invention, it is possible to easily increase the variation of attributes of a dialogue partner for role-playing, and to realize role-playing according to the attributes of the dialogue partner.

### BRIEF DESCRIPTION OF THE DRAWINGS

FIG. 1 is a block diagram showing a configuration example of a dialogue support system 1 according to an embodiment.

FIG. 2 is a diagram showing an outline of processing performed by the dialogue support system 1 according to the embodiment.

FIG. 3 is a flowchart showing an example of a processing procedure of the dialogue support system 1 according to the embodiment.

FIG. 4 is a diagram showing an example of customer-defined information including a variable name and a character string according to the embodiment.

FIG. 5 is a diagram showing an example of a persona generation prompt in the embodiment.

FIG. 6 is a diagram showing an example of variables generated from a persona generation prompt in the embodiment.

FIG. 7 is a diagram showing an example of a persona designation prompt in the embodiment.

FIG. 8 is a diagram showing an example of persona designation information in the embodiment.

FIG. 9 is a diagram showing an example of an evaluation prompt in the embodiment.

### DETAILED DESCRIPTION OF THE INVENTION

A dialogue support system, a dialogue support method, and a storage medium to which the present invention is applied will be described below with reference to the drawings.

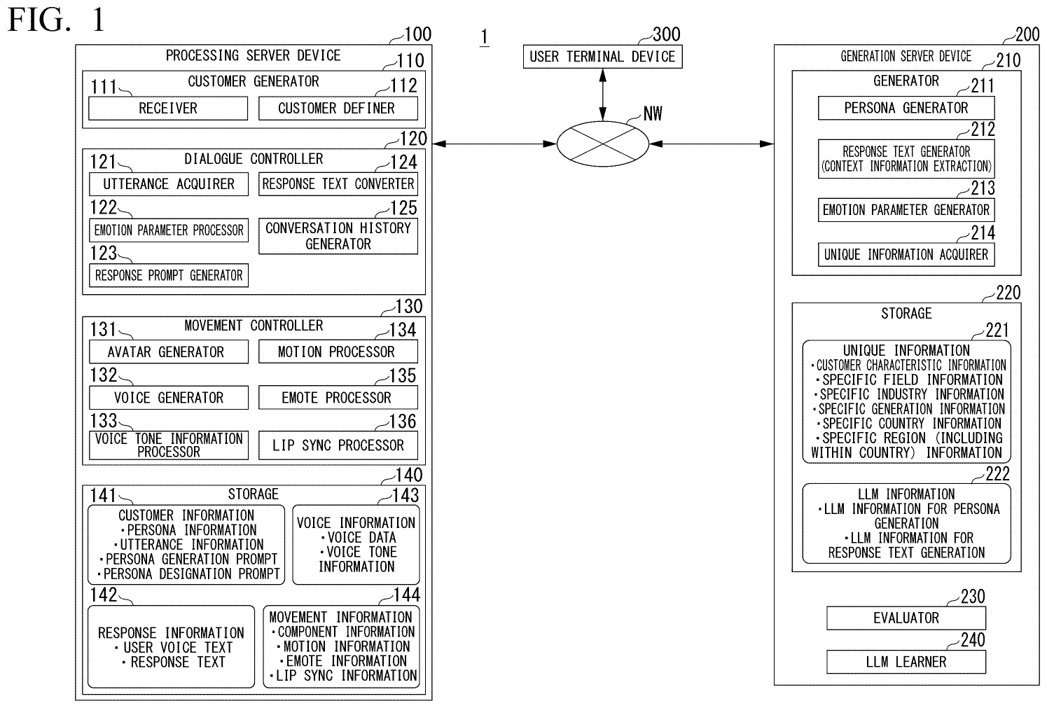

FIG. 1 is a block diagram showing a configuration example of a dialogue support system 1 according to an embodiment.

The dialogue support system 1 according to the embodiment supports a dialogue between a user and an avatar characterized by a specific persona. The dialogue support system 1 generates a persona based on information designated by a user, for example, and controls an avatar corresponding to the generated persona, so that the user and the avatar perform a role play. A role play is, for example, training for new employees, sales training, language training, communication training, and the like by using a virtual avatar as a dialogue partner with the user. Furthermore, a role play in the embodiment includes playing between people of different nationalities and places of origin.

The dialogue support system 1, for example, includes a processing server device 100, a generation server device 200, and a user terminal device 300. The processing server device 100, the generation server device 200, and the user terminal device 300 are communicatively connected via a network NW such as the Internet. The processing server device 100, the generation server device 200, and the user terminal device 300 may be connected to each other via either wired or wireless communication, and may include a general-purpose network such as the Internet, and a private network such as local 5G or WiFi (registered trademark). The processing server device 100, the generation server device 200, and the user terminal device 300 may each have a communication interface, such as a network interface card (NIC) or a wireless communication module, for connecting to a network, and may exchange information with one another.

The user terminal device 300 is, for example, an information processing device operated by a user who has a dialogue with an avatar. The user terminal device 300, for example, includes a speaker, a microphone, a display device, an operation unit, and a processing unit such as a CPU.

The processing server device 100, for example, includes a processor that performs processing in response to requests received from the generation server device 200 and the user terminal device 300, and transmits processing results to the generation server device 200 and the user terminal device 300. The processing server device 100, for example, includes a customer generator 110, a dialogue controller 120, a movement controller 130, and a storage 140. The customer generator 110, the dialogue controller 120, and the movement controller 130 are functional units realized by an information processing circuit that performs various processes by causing a central processing unit (CPU) to execute a program, for example. Further, some or all of these functional units may be realized by hardware such as large scale integration (LSI), application specific integrated circuit (ASIC), or field-programmable gate array (FPGA), or may be realized by cooperation of software and hardware. The storage 140 is realized, for example, by a hard disk drive (HDD), a solid state drive (SSD), a flash memory, an electrically erasable programmable read only memory (EEPROM), a read only memory (ROM), or a random access memory (RAM), or a hybrid storage device that uses a plurality of these. A part or the whole of the storage 140 may be realized by an external storage device that can be accessed via various networks. An example of an external storage device is a network attached storage (NAS) device.

The customer generator 110 generates customer information. The customer information indicates the customers assumed by the user. The customer corresponds to an avatar that is a dialogue partner of the user in a role play, for example. The customer generator 110, for example, includes a receiver 111 and a customer definer 112. The receiver 111 receives persona information based on information received from the user terminal device 300. The persona information is customer-defined information that indicates a persona that characterizes a customer (dialogue partner) for the user. A persona may be a virtual character, or a character based on information about a real person. In addition, the persona information may be based in part on information about a person who actually exists, or on information about a person who has already passed away. The customer definer 112 generates customer information based on the persona information received by the receiver 111.

The dialogue controller 120 controls an avatar corresponding to a persona based on a persona generation prompt generated by a persona generator 211, and performs processing for controlling the dialogue between the avatar and the user. The dialogue controller 120, for example, includes an utterance acquirer 121, an emotion parameter processor 122, a response prompt generator 123, a response text converter 124, and a conversation history generator 125.

The utterance acquirer 121 acquires utterance information that indicates a user's utterance input from the user terminal device 300, and converts the acquired utterance information into text data.

The emotion parameter processor 122 performs processing for setting and updating emotion parameters. The emotion parameter is a numerical value indicating the emotion of the avatar (customer). The emotion parameters are, for example, information that express emotions such as joy, anger, sadness, enjoyment, confidence, confusion, and fear on a five-level scale from 1 to 5. In the present embodiment, the configuration related to the emotion of the customer, such as the emotion parameter processor 122, will be described, but the present invention is not limited thereto, and the configuration related to the emotion of the customer may not be provided.

The response prompt generator 123 generates a response prompt including text data of the user's voice and emotion parameters, and transmits the generated response prompt to the generation server device 200.

The response text converter 124 converts the response text acquired from the generation server device 200 into voice data.

The conversation history generator 125 generates history information indicating the history of conversations between a user and an avatar.

The movement controller 130 performs processing for controlling the movement of the avatar. The movement controller 130, for example, includes an avatar generator 131, a voice generator 132, a voice tone information processor 133, a motion processor 134, an emote processor 135, and a lip sync processor 136.

The avatar generator 131 generates an avatar. The avatar generator 131 generates, for example, component information representing content for displaying an avatar based on an image showing the appearance of a customer.

The voice generator 132 generates voice data to be output to the user. The voice generator 132 generates voice data that reproduces, for example, the customer's natural voice. In a case where the persona information includes a nationality, a place of origin, or a region, the voice generator 132 may generate voice data in a language corresponding to the nationality or the place of origin based on the persona generation prompt generated by the persona generator 211.

The voice tone information processor 133 processes the voice data based on the voice tone information corresponding to the emotion parameters. In a case where the persona information includes nationality, place of origin, or region, the voice tone information processor 133 may process the voice data generated by the voice generator 132 based on the nationality or the place of origin included in the persona information. The voice tone information processor 133 may process the voice data to reflect, for example, a tone (for example, a speaking speed), a pitch of the voice, or a tone of the voice. Furthermore, the voice tone information processor 133 may process the voice data to reflect dialects and intonations according to differences in nationality or place of origin.

Element data for generating the voice may include a plurality of pieces of element data corresponding to a plurality of languages. The voice generator 132 selects one of a plurality of languages based on the nationality or the place of origin included in the persona information, and generates voice data in the selected language. Accordingly, the voice generator 132 generates voice data using synthesized voice data corresponding to each of the multiple languages.

The motion processor 134 controls the motion of the avatar based on emotion parameters and the content of the response text. For example, the motion of the avatar represents the movement of the entire avatar or the movement of the avatar's hands.

The emote processor 135 controls the facial expression of the avatar based on emotion parameters and the content of the response text. The emote processor 135 controls the movements of the avatar's eyes, eyebrows, mouth, and the like, for example.

The lip sync processor 136 controls the movement of the avatar's lips based on emotion parameters and the content of the response text.

The storage 140 stores, for example, customer information 141, response information 142, voice information 143, and movement information 144. The customer information 141, for example, includes persona information, utterance information, persona generation prompts, and persona designation prompts. The persona generation prompt is detailed information for generating a persona. The persona designation prompt is information that indicates the persona that is designated when the user and the avatar actually have a dialogue such as a role play.

The response information 142, for example, includes user voice text and response text, and may include an initial emotion parameter value and a current emotion parameter value. The voice information 143, for example, includes voice data such as a user voice and a response voice, and voice tone information, and may include an emotion parameter. The movement information 144, for example, includes emotion parameters, component information, motion information, emote information, and lip sync information. The motion information is a default value representing the motion of the avatar, the emote information is a defined value representing the emote of the avatar, and the lip sync information is a default value representing the lip sync of the avatar.

The generation server device 200, for example, performs processing in response to a request received from the processing server device 100 and transmits the processing result. The generation server device 200, for example, includes a generator 210, a storage 220, an evaluator 230, and an LLM learner 240. The generator 210, the evaluator 230, and the LLM learner 240 are functional units realized by an information processing circuit that performs various processes by causing a CPU to execute a program, for example. The storage 220 is realized, for example, by a recording device such as an HDD or an SSD, or a hybrid storage device that uses a plurality of these, and may also be realized by an external storage device that can be accessed via various networks, such as a NAS device.

The generator 210, for example, includes the persona generator 211, a response text generator 212, an emotion parameter generator 213, and a unique information acquirer 214.

The persona generator 211 inputs the persona information acquired from the processing server device 100 into a first large language model, and generates a persona generation prompt based on an output of the first large language model. The persona information may be existing items including a gender, an age, a personality, a place of origin (including within a country), a speaking style, a tone, or a dialect of the persona. Further, the first large language model may be at least one of an item designated based on a user's operation, an item related to characteristics of customers in a specific industry, and an item related to characteristics of customers in a specific generation.

The first large language model is configured to learn, as learning data, persona information including existing items including a gender, an age, a personality, a place of origin (including within a country), a speaking style, a tone, or a dialect of the persona, at least one of an item designated based on a user's operation, an item related to characteristics of customers in a specific industry, and an item related to characteristics of customers in a specific generation, and a persona generation prompt, and output a persona generation prompt in a case where at least one of persona information including existing items including a gender, an age, a personality, a place of origin (including within a country), a speaking style, a tone, or a dialect of the persona, or at least one of an item designated based on a user's operation, an item related to characteristics of customers in a specific industry, and an item related to characteristics of customers in a specific generation is input.

The persona generator 211 may input persona information and information related to a specific field into a first large language model, and generate a persona generation prompt indicating characteristics of a persona corresponding to the specific field based on an output of the first large language model. The information related to a specific field is various types of information related to a field that is a topic of the dialogue. The information related to a specific field may be, for example, customer characteristic information such as customer issues related to product purchases that are empirically assumed according to a specific industry, a specific generation, a specific nationality, or a specific place of origin. The information related to a specific field is acquired as unique information by the unique information acquirer 214. The specific field may be a field, an industry, a task, and the like in which the user wishes to improve.

The persona information includes a nationality or a place of origin, and the persona generator 211 may input existing items including the persona's nationality or place of origin as persona information into a persona generation prompt (a first large language model), and generate a persona generation prompt based on an output of the persona generation prompt.

The response text generator 212 generates a response text from the response prompt generated by the response prompt generator 123, the conversation history generated by the conversation history generator 125, and the unique information acquired by the unique information acquirer 214. The response text generator 212 inputs, for example, a response prompt, a conversation history between the user and the avatar, and unique information into a second large language model, and generates a response text based on the second large language model. The response text generator 212 may extract context information of the conversation and generate a response text based on the context information in addition to the response prompt, the conversation history, and the unique information. The first large language model is a large language model (LLM) using a neural network, for example. The second large language model may be the same LLM as the first large language model, or they may be different LLMs.

The emotion parameter generator 213 generates or updates emotion parameters according to the content of the generated response text.

The unique information acquirer 214 acquires unique information which is information unique to a dialogue such as a role play. The unique information is acquired from a storage device having, for example, customer characteristic information, specific field information, specific industry information, specific generation information, and specific region (both within and outside a country) information, which are not shown.

The storage 220, for example, includes unique information 221 and LLM information 222.

The unique information 221 includes customer characteristic information, specific field information, specific industry information, specific generation information, specific country and region information, and the like. The customer characteristic information indicates the characteristics of a customer who dialogues with the user. The customer characteristic information is, for example, information such as an age, a gender, an occupation, a speaking style, a tone, a personality, a nationality, and a place of origin. The specific field information indicates the field of the dialogue between the user and the customer. The specific industry information indicates the industry of the dialogue between the user and the customer. The specific generation information indicates a generation of the customer.

The LLM information 222 is parameter information for an LLM (a first large language model) for generating a persona generation prompt. The LLM information 222 may include parameter information for an LLM that generates a persona designation prompt based on a persona generation prompt. The LLM for generating the persona generation prompt is a machine learning model trained using past data of the persona generation prompt and the persona designation prompt as learning data, and is configured to output a persona designation prompt in a case where a persona generation prompt is input.

The LLM information 222 may include parameter information for an LLM (a second large language model) for generating response text based on the persona designation prompt. The LLM for generating the response text is a machine learning model trained using past data of the persona designation prompt and the response text as learning data, and is configured to output response text in a case where a persona designation prompt is input.

The LLM information 222 may include parameter information for an LLM that generates an evaluation prompt based on the conversation history. The LLM that generates the evaluation prompt is a machine learning model trained using past data of the conversation history and the evaluation prompt as learning data, and is configured to output an evaluation prompt in a case where a conversation history is input.

In addition, the LLM for generating the persona generation prompt, the LLM for generating the persona designation prompt, the LLM for generating the response text, and the LLM for generating the evaluation prompt may be a single LLM or may be different LLMs.

The LLM learner 240 performs processing for learning an LLM (a first large language model) for generating a persona generation prompt and an LLM (a second language model) for generating response text. In addition, the LLM learner 240 may learn an LLM that generates a persona designation prompt, and may learn an LLM that generates an evaluation prompt.

In the embodiment, as shown in FIG. 1, the dialogue support system 1 distributes the functional configuration (functional units) between the processing server device 100 and the generation server device 200. However, the present invention is not limited thereto, and the functional units may be distributed in other configurations, the functional units of the processing server device 100 and the generation server device 200 may be aggregated into one device, a plurality of functional units may be combined into one functional unit, or one function may be distributed among a plurality of functional units.

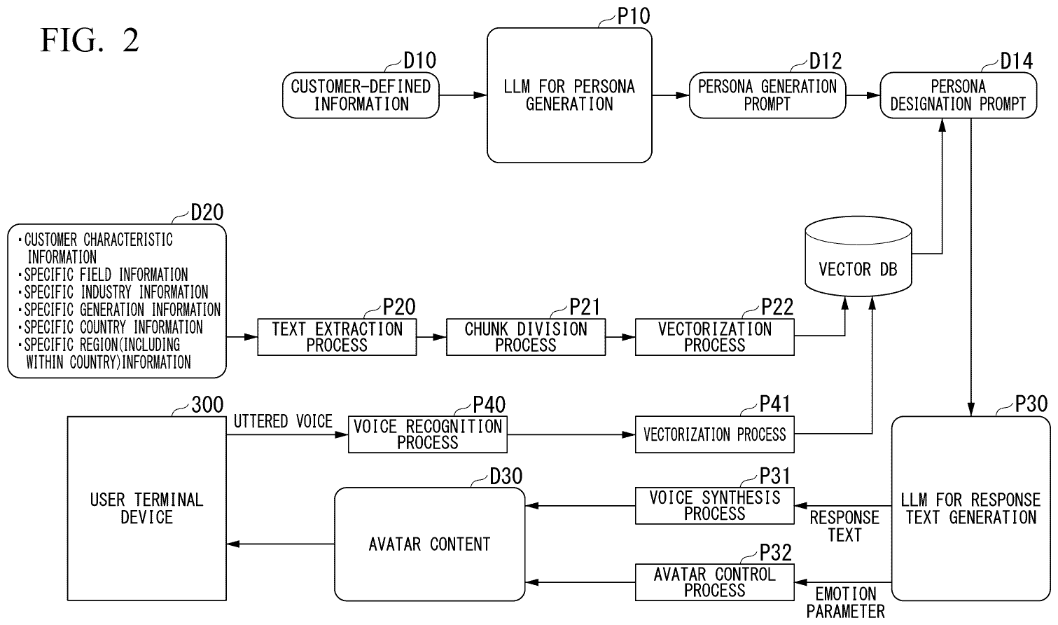

FIG. 2 is a diagram showing an outline of processing performed by the dialogue support system 1 according to the embodiment.

The receiver 111 and the customer definer 112 generate customer-defined information D10 and transmit the customer-defined information D10 to the generation server device 200. The persona generator 211 inputs the customer-defined information D10 to an LLM for persona generation (P10), and generates a persona generation prompt D12 based on an output of the LLM for persona generation (P10). The LLM for persona generation (P10) is configured to learn, for example, past data of the customer-defined information and the persona generation prompt as learning data, and to output a persona generation prompt D12 when customer-defined information D10 is input. The persona generator 211 generates a persona designation prompt D14 when the user performs a role play. The persona designation prompt D14 is output to an LLM for response text generation.

The generation server device 200 acquires unique information D20 such as a specific field for performing a role play, and processes the unique information D20 in the following order: a text extraction process P20, a chunk division process P21, and a vectorization process P22, and stores vectors corresponding to the unique information D20 in a vector database (the storage 220). The processing server device 100 performs a voice recognition process P40 on the user's uttered voice acquired from the user terminal device 300, and performs a vectorization process P41 on text information processed by the voice recognition process P40, and a reference result to a vector database using a vector corresponding to the uttered voice as a query is extracted from the vector database. The vectorized unique information D20 and the text information processed by the voice recognition process P40 are output to an LLM for response text generation (P30) together with the persona designation prompt D14.

The generation server device 200 inputs the persona designation prompt D14, the unique information D20, and the text information processed by the voice recognition process P40 into the LLM for response text generation (P30), performs a voice synthesis process P31 on the response text output from the LLM for response text generation (P30), and performs an avatar control process P32 based on the emotion parameters output from the LLM for response text generation (P30), thereby transmitting avatar content D30 to the user terminal device 300. Accordingly, the user terminal device 300 can perform display or voice output using the avatar content D30.

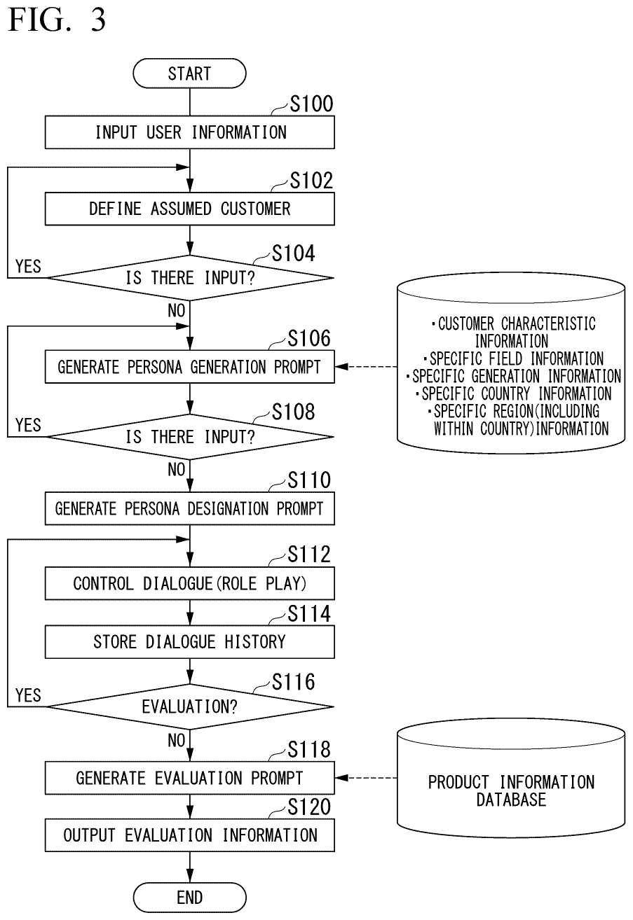

FIG. 3 is a flowchart showing an example of a processing procedure of the dialogue support system 1 according to the embodiment.

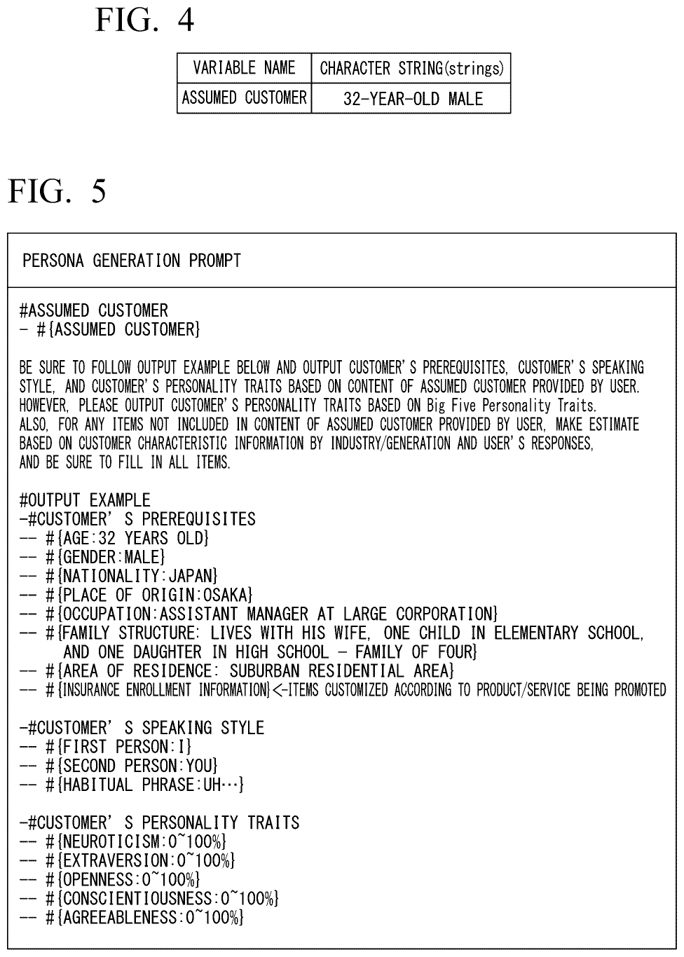

First, the processing server device 100 inputs user information related to a user who will dialogue with an avatar (step S100). The user information is character string data that characterizes a user, such as a new employee, a sales manager, a specific nationality, or a place of origin. Next, the processing server device 100 defines the customers assumed by the user (step S102). At this time, the processing server device 100 receives persona information indicating a persona that characterizes the dialogue partner of the user from the user terminal device 300 via the receiver 111, and holds the persona information as a variable, for example, as shown in FIG. 4.

FIG. 4 is a diagram showing an example of customer-defined information including a variable name and a character string according to the embodiment. The receiver 111 determines whether or not there is any further input (step S104), and in a case where an input is received, the process of step S102 is repeated, and in a case where no input is received, the customer-defined information is confirmed. The processing server device 100 transmits the customer-defined information to the generation server device 200.

The persona generator 211 inputs the customer-defined information and the unique information stored in the storage 220 to the LLM for persona generation, and generates a persona generation prompt based on an output of the LLM for persona generation (step S106).

FIG. 5 is a diagram showing an example of a persona generation prompt in the embodiment. The persona generation prompt includes, for example, text data that describes the prerequisites of the customer, the speaking style of the customer, and the personality traits of the customer. The prerequisites of the customer include, for example, items according to the role play, such as an age, a gender, an occupation, a family structure, an area of residence, a nationality, a place of origin, and insurance enrollment information. For example, in a case where a customer's place of origin is Osaka as a prerequisite, a prompt corresponding to the Kansai dialect can be generated as a persona generation prompt, and it is also possible to control the tone or dialect depending on the area of residence. Furthermore, by setting, as a prerequisite of the customer, for example, the place of origin as California, it is possible to generate a persona generation prompt capable of reproducing a person who is strongly influenced by California culture.

The speaking style of the customer may be, for example, first person, second person, habitual phrases, interjections, dialect, and the like. The personality traits of the customer may be, for example, neuroticism, extraversion, openness, conscientiousness, agreeableness, and the like. The persona generator 211 determines whether or not there is any input for other items and the like from the user terminal device 300 (step S108), and in a case where an input is received, the process of step S106 is repeated, and in a case where no input is received, the persona generation prompt is confirmed.

The persona generator 211 stores the generated persona generation prompts as variables in the storage 220.

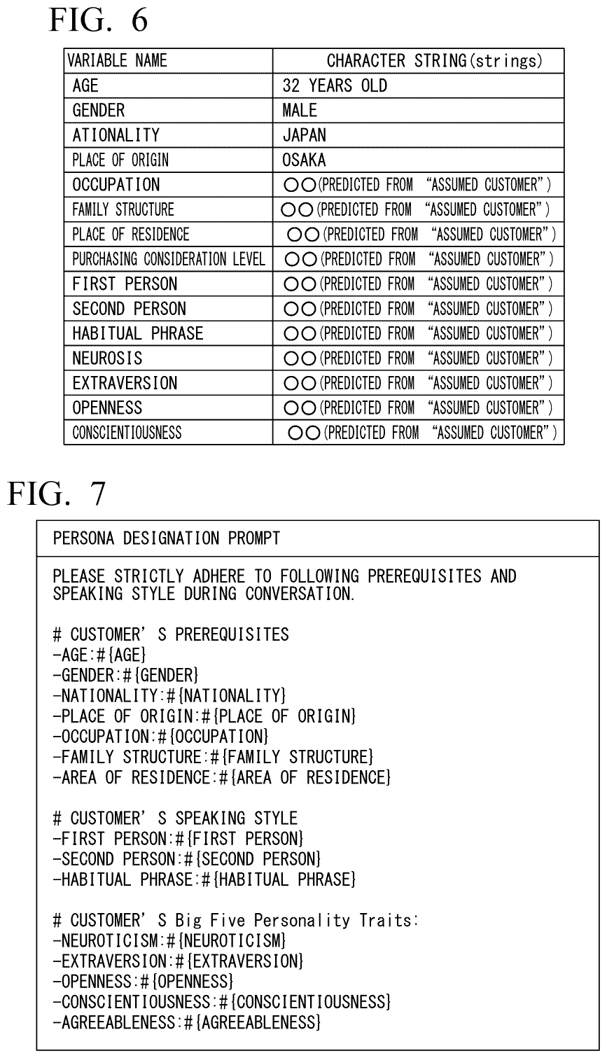

FIG. 6 is a diagram showing an example of variables generated from a persona generation prompt in the embodiment. The variables generated from the persona generation prompt are information predicted based on an output of the LLM for persona generation after inputting customer-defined information into the LLM for persona generation.

The persona generator 211 may input existing items including at least one of a gender, an age, a personality, a place of origin (including within a country), a speaking style, a tone, and a dialect of the persona as persona information (customer-defined information) into an LLM for persona generation (a first large language model), and further input at least one of items designated based on a user's operation, items related to the characteristics of customers in a specific industry, and items related to the characteristics of customers in a specific generation into the LLM for persona generation, and generate a persona generation prompt based on an output of the LLM for persona generation. In addition, the persona generator 211 may input existing items including the speaking style in addition to the gender, the age, and the personality of the persona into the LLM for persona generation. Accordingly, the persona generator 211 can realize retrieval-augmented generation (RAG) by inputting various types of information into the LLM for persona generation, and can generate highly accurate persona generation prompts in response to user requests.

The persona generator 211 may input items related to issues seen by customers regarding a specific product into an LLM for persona generation (a first large language model), and generate a persona generation prompt based on an output of the LLM for persona generation. This LLM for persona generation is a machine learning model that is configured to learn, for example, information related to issues seen by customers regarding a specific product and past data of persona generation prompts as learning data, and to output a persona generation prompt in a case where an item related to issues seen by customers regarding a specific product is input. The items related to issues seen by customers regarding a specific product are information empirically assumed in a specific field or a specific industry, or information such as customer issues related to the purchase of the product assumed based on market analysis or survey results. The items related to issues seen by customers regarding a specific product may be added or modified as variables by the user.

In addition, the persona generator 211 may input existing items including the persona's nationality or place of origin as persona information into an LLM for persona generation (a first large language model), and generate a persona generation prompt based on an output of the LLM for persona generation. The LLM for persona generation is configured to learn past data of the existing items including the persona's nationality or place of origin and the persona generation prompt as learning data, and to output a persona generation prompt in a case where an existing item including a persona's nationality or place of origin is input.

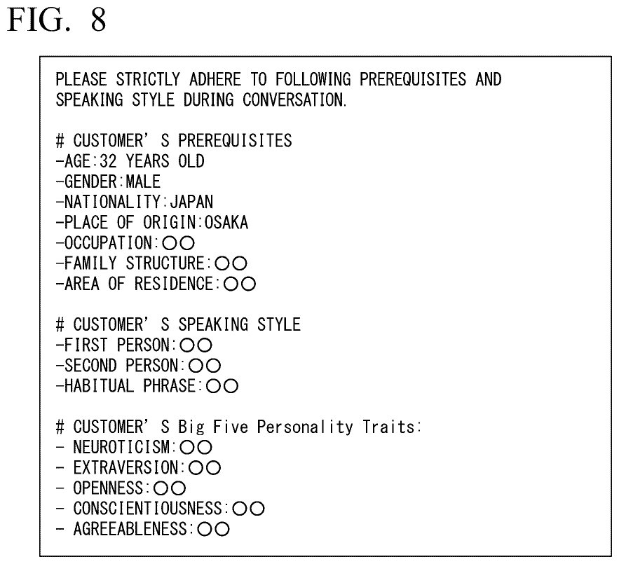

Next, the persona generator 211 generates a persona designation prompt (step S110). FIG. 7 is a diagram showing an example of a persona designation prompt in the embodiment. The persona generator 211 may input a variable corresponding to the persona generation prompt into the LLM, and generate a persona designation prompt based on an output of the LLM. The variable corresponding to the persona generation prompt may be selected based on a user's operation, or may be extracted from the persona generation prompt randomly or according to a predetermined rule. The persona generator 211 transmits the persona designation information as shown in FIG. 8 to the processing server device 100 based on the persona designation prompt. FIG. 8 is a diagram showing an example of persona designation information in the embodiment.

Next, the dialogue controller 120 controls an avatar corresponding to the persona based on the persona designation information, and controls a dialogue between the avatar and the user (step S112). Accordingly, the dialogue controller 120 performs a role play through the dialogue between the user and the avatar. The utterance acquirer 121 acquires utterance information indicating a user's utterance, and the conversation history generator 125 stores the conversation history (step S114).

Next, the processing server device 100 determines whether or not to evaluate the user (step S116). In a case where the processing server device 100 does not evaluate the user, the processes of steps S112 and S114 are repeated. For example, in a case where the processing server device 100 detects a user's utterance of “evaluate the role play”, the processing server device 100 determines to evaluate the user and transmits the conversation history to the generation server device 200.

The timing for evaluating a user (role play) may be at the end of the role play, that is, the entire role play (such as a business negotiation), but is not limited thereto, and evaluation may be performed after each conversation rally (each round trip of conversation) during the role play. For example, at the start of a role play, the processing server device 100 allows the user to select an overall evaluation (end evaluation) or an individual evaluation. The overall evaluation is a process of evaluating the entire conversation history, and the individual evaluation is a process of evaluating each rally during the conversation (including a pair of inquiry and response of the conversation). In a case where the overall evaluation is selected, the processing server device 100 transmits the conversation history to the generation server device 200 at the timing when it detects a user's utterance, for example, “evaluate the role play”. In a case where the individual evaluation is selected, the processing server device 100 transmits the conversation history for one rally to the generation server device 200 at the timing when it detects a break in a rally during the conversation. The generation server device 200 stores the results of the individual evaluation performed based on the conversation history for one rally in the storage 220, and transmits the results of one or more individual evaluations to the processing server device 100 at the timing when the role play ends. Accordingly, the results of the individual evaluation can be presented to the user.

Further, the role play (such as a business negotiation) may be evaluated as a whole, and each conversation rally (each round trip of conversation) during the role play may be evaluated at the same time. At the start of a role play, for example, the user selects whether to perform both an overall evaluation and an individual evaluation in the processing server device 100. The processing server device 100 transmits a conversation history for one rally to the generation server device 200 at the timing when it detects a break in a rally during the conversation, and further transmits the conversation history to the generation server device 200 at the timing when it detects a user's utterance of “evaluate the role play”. The generation server device 200 stores the results of the individual evaluation performed based on the conversation history for one rally in the storage 220. The generation server device 200 transmits the result of the overall evaluation and the results of one or more individual evaluations to the processing server device 100 at the timing when the role play ends. Accordingly, the result of the overall evaluation and the result of the individual evaluation can be presented to the user on the same screen.

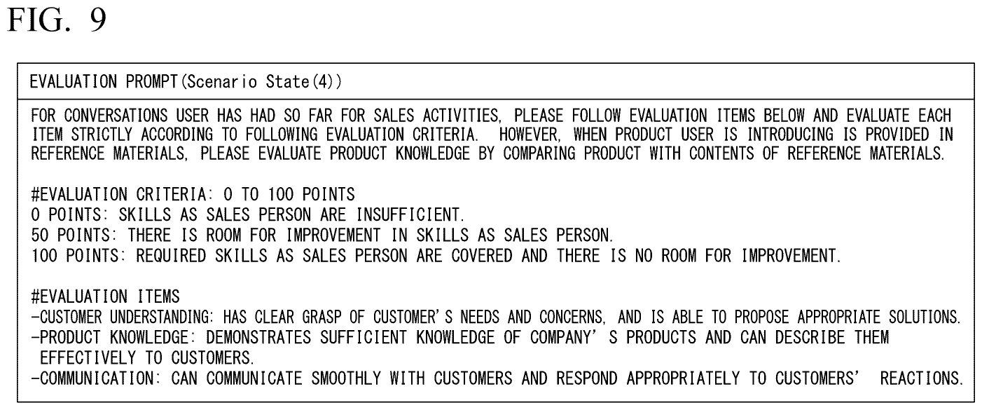

The evaluator 230 evaluates the user based on the utterance information acquired by the utterance acquirer 121 (step S118). At this time, the evaluator 230 generates the evaluation prompt based on the conversation history acquired from the processing server device 100. The evaluator 230 may input the conversation history to an LLM that generates an evaluation prompt, and generate the evaluation prompt based on an output of the LLM. For example, in a case where a user describes a product in a role play, the evaluator 230 may input the conversation history and information stored in the product information database to an LLM that generates an evaluation prompt, and generate the evaluation prompt based on an output of the LLM that generates an evaluation prompt. FIG. 9 is a diagram showing an example of an evaluation prompt in the embodiment. The evaluation prompt includes, for example, an evaluation item, evaluation criteria, evaluation points, customer understanding evaluation, product knowledge evaluation, and communication evaluation for conversations for sales activities.

The receiver 111 may receive usage purpose information that indicates the usage purpose for which the user dialogues with the avatar, and the evaluator 230 may evaluate the user based on evaluation items set according to the usage purpose. The evaluator 230 may, for example, input the usage purpose information to an LLM that generates an evaluation prompt, and generate an evaluation prompt including evaluation for the usage purpose.

The evaluator 230 may acquire the utterance information of the user and the utterance information of the avatar from the utterance acquirer 121. Furthermore, the evaluation items may include at least one of the understanding level of the customer based on the utterance information of the user and the utterance information of the avatar, the accuracy of product knowledge, the accuracy of specialized knowledge, and communication ability. Furthermore, the evaluation items may be, for example, evaluations based on evaluation criteria for each individual company (individual company evaluations). Individual company evaluations may include, for example, whether a mobile phone dealer is able to propose switching to a more advantageous plan (such as a family plan) based on customer information, whether a car dealer is able to propose three or more types of quotes, and whether an insurance dealer is able to make the next appointment and close the deal.

The evaluator 230 outputs evaluation information to the processing server device 100 as a result of evaluating the conversation of the user based on the evaluation prompt (step S120). Accordingly, the processing server device 100 can transmit evaluation information to the user terminal device 300, and the user terminal device 300 can present the evaluation to the user.

As described above, with the dialogue support system 1 according to the embodiment, persona information indicating a persona that characterizes a dialogue partner of the user is received, a persona generation prompt indicating the characteristics of the persona is generated using a first large language model based on the persona information, an avatar corresponding to the persona is controlled based on the persona generation prompt generated by the persona generator, and the dialogue between the avatar and the user is controlled. According to this dialogue support system 1, for example, by inputting persona information based on a user's operation, a persona generation prompt can be generated using the first large language model. Therefore, it is possible to easily increase the variation of attributes of the dialogue partner for role-playing and realize role-playing according to the attributes of the dialogue partner.

The functions of the processing server device 100, the generation server device 200, and the user terminal device 300 in the above-mentioned embodiment may be realized by a computer. In this case, the function may be realized by recording a program for realizing the function on a computer-readable recording medium, and reading and executing the program recorded on the recording medium into a computer system. The term “computer system” here includes an OS and hardware such as a peripheral device. In addition, the term “computer-readable recording medium” refers to a portable medium such as a flexible disk, a magneto-optical disk, a ROM, or a CD-ROM, and a storage device such as a hard disk built into a computer system. Furthermore, the term “computer-readable recording medium” may include a medium that dynamically holds the program for a short period, such as a communication line for transmitting the program via networks such as the Internet and communication lines such as telephone lines, and a medium that holds a program for a certain period, such as a volatile memory inside a computer system that is a server or a client in that case. Furthermore, the above program may be for realizing part of the functions described above, or may be capable of realizing the functions described above in combination with a program already recorded in a computer system, or may be realized using a programmable logic device such as a field programmable gate array (FPGA).

While preferred embodiments of the invention have been described and illustrated above, it should be understood that these are exemplary of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

### EXPLANATION OF REFERENCES

1: Dialogue support system
100: Processing server device
110: Customer generator
111: Receiver
112: Customer definer
120: Dialogue controller
121: Utterance acquirer
122: Emotion parameter processor
123: Response prompt generator
124: Response text converter
125: Conversation history generator
130: Movement controller
131: Avatar generator
132: Voice generator
133: Voice tone information processor
134: Motion processor
135: Emote processor
136: Lip sync processor
140: Storage
141: Customer information
142: Response information
143: Voice information
144: Movement information
200: Generation server device
210: Generator
211: Persona generator
212: Response text generator
213: Emotion parameter generator
214: Unique information acquirer
220: Storage
222: LLM information
230: Evaluator
240: LLM learner
300: User terminal device

What is claimed is:

1. A dialogue support system comprising:
a receiver configured to receive persona information indicating a persona that characterizes a dialogue partner of a user;
a persona generator configured to generate a persona generation prompt indicating characteristics of the persona based on the persona information received by the receiver using a large language model; and
a dialogue controller configured to control an avatar corresponding to the persona based on the persona generation prompt generated by the persona generator, and to control a dialogue between the avatar and the user.

2. The dialogue support system according to claim 1,
wherein the persona generator is configured to input the persona information and information related to a specific field into the large language model, and generate a persona generation prompt indicating characteristics of a persona corresponding to the specific field based on an output of the large language model.

3. The dialogue support system according to claim 1,
wherein the persona generator is configured to input existing items including a gender, an age, a personality, a place of origin (including within a country), a speaking style, a tone, or a dialect of the persona as the persona information into the large language model, and further input at least one of an item designated based on an operation of the user, an item related to characteristics of customers in a specific industry, or an item related to characteristics of customers in a specific generation into the large language model, and generate the persona generation prompt based on an output of the large language model.

4. The dialogue support system according to claim 1,
wherein the persona information includes a nationality or a place of origin, and
the persona generator is configured to input existing items including a nationality or a place of origin of the persona as the persona information into the large language model, and generate the persona generation prompt based on an output of the large language model.

5. The dialogue support system according to claim 4, further comprising:
a voice generator configured to generate voice data in a language corresponding to a nationality or a place of origin based on the persona generation prompt generated by the persona generator; and
a voice tone information processor configured to process the voice data generated by the voice generator based on the nationality or the place of origin included in the persona information.

6. The dialogue support system according to claim 5,
wherein the voice generator is configured to select one of a plurality of languages based on the nationality or the place of origin included in the persona information, and generate the voice data in the selected language.

7. The dialogue support system according to claim 1,
wherein the persona generator is configured to input an item related to an issue seen by a customer regarding a specific product into the large language model, and generate the persona generation prompt based on an output of the large language model.

8. The dialogue support system according to claim 1, further comprising:
an utterance acquirer configured to acquire utterance information indicating an utterance of the user; and
an evaluator configured to evaluate the user based on the utterance information acquired by the utterance acquirer.

9. The dialogue support system according to claim 8,
wherein the receiver is configured to receive usage purpose information indicating a usage purpose for which the user dialogues with the avatar, and
the evaluator is configured to evaluate the user based on an evaluation item set according to the usage purpose.

10. The dialogue support system according to claim 9,
wherein the utterance acquirer is configured to acquire the utterance information of the user and utterance information of the avatar, and
the evaluation item includes at least one of an understanding level of a customer, accuracy of product knowledge, accuracy of specialized knowledge, or communication ability based on the utterance information of the user and the utterance information of the avatar.

11. A dialogue support method comprising:
a step in which a server device receives persona information indicating a persona that characterizes a dialogue partner of a user;
a step in which the server device generates a persona generation prompt indicating characteristics of the persona based on the persona information using a large language model; and
a step in which the server device controls an avatar corresponding to the persona based on the persona generation prompt, and controls a dialogue between the avatar and the user.

12. A non-transitory computer-readable storage medium storing a program that causes a computer of a server device to execute:
a step of receiving persona information indicating a persona that characterizes a dialogue partner of a user;
a step of generating a persona generation prompt indicating characteristics of the persona based on the persona information using a large language model; and
a step of controlling an avatar corresponding to the persona based on the persona generation prompt, and controlling a dialogue between the avatar and the user.
